(19) United States
(12) Patent Application Publication
(10) Pub. No.: US 2008/0176037 A1
(43) Pub. Date: Jul. 24, 2008

(54) Transparent paper and method of making same

(75) Inventor: Pauline Ozoemena Ukpabi, Oshkosh, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 11/655,101

(22) Filed: Jan. 19, 2007

(51) Int. Cl. B32B 3/10

(52) U.S. Cl. 428/137; 428/142

(57) ABSTRACT

The invention teaches a novel paper substrate having a transparent field of a dense array of a plurality of laser-formed microperforations. The resultant paper can be useful as a replacement for glassine paper, and can be useful in secure documents. The transparent field is integral to the paper substrate and can be formed by laser techniques surprisingly resulting in a transparent field retaining acceptable strength characteristics after lasing. The transparent field acts as a self authentication device.

### BACKGROUND OF THE INVENTION

1. Field of the Invention

The present invention relates to paper generally. More particularly, the present invention also relates to secure substrates and generally to the field of transparent substrates, anti-counterfeiting and authentication devices and methods.

2. Description of the Related Art

A variety of transparent, glassine and cellophane papers are known. Manufacture of these papers can involve processes such as calendaring and embossing. Typically, however, transparentizing of paper is accomplished by treating the paper substrate with a transparentizing material and curing the transparentizing material using heat, uv or other curing methods to help prevent migration of the transparentizing material from the application site. Resins such as acrylic, polyester and urethane are typically used as the transparentizing medium as described in U.S. Pat. Nos. 6,902,770; 5,849,398; 5,055,354; 4,569,888; 4,513,056; 4,416,950; and 4,271,227. Solvents such as petroleum hydrocarbons, oils and waxes may also be used to impart transparency. A typical example is found in the production of true vegetable parchment paper using sulfuric acid solution. These transparentizing materials are typically applied as a solvent mixture to penetrate, infuse or coat the paper and impart transparency.

Such chemical treatments to achieve transparency have their limitations and often such resin-treated substrates are difficult to recycle.

Often, transparent papers such as glassine papers must be cut and separately attached to an envelope window opening by gluing or other fastening means.

Separate cutting and gluing steps are needed to utilize the transparent papers since the transparent regions are not integral to the balance of the paper. The transparent components must typically be separately applied.

A variety of secure documents are known used in bank notes, credit cards, tickets, title documents, and similar instruments of value. A variety of security tokens or authentication devices are also known.

Australian Patent No. 488,652 (Application No. 73762/74) filed Sep. 26, 1973 by Sefton Davidson Hamann et al., assigned to the Commonwealth Scientific and Industrial Research Organization teaches a security token comprising a laminate of at least two layers of plastic sheeting. Positioned between the sheeting is an optically variable device such as a diffraction grating, liquid crystal, moiré patterns and similar patterns produced by cross-gratings with or without superimposed, refractive, lenticular and transparent grids. These devices yield variable interference patterns.

Amidror et al., U.S. Pat. Nos. 5,995,618; 6,819,775; and 7,058,202 teach methods for authenticating documents using the intensity profile of moiré patterns. The various dot screens and perforations taught in Amidror while useful as authentication devices, however do not teach formation of transparent papers, or replacements for glassine paper.

It is an object of the present invention to teach a distinctive form of a document or token with a transparent field that is difficult to reproduce using xerographic methods and a method of making same. Structural aspects of the substrate are often more difficult to reproduce by xerography and therefore provide an elevated level of security.

### SUMMARY OF THE INVENTION

The present invention is a novel paper substrate having a transparent field, the transparent field comprising an array of a plurality of laser-formed microperforations separated by a land area, the array of microperforations having a density rate of at least 1200 microperforations per square centimeter, the land area separating adjacent microperforations being at least 50 microns and not exceeding 600 microns. In an alternative embodiment, the transparent field is a close packed array of a plurality of laser microperforations having a density rate of at least 2000 microperforations per square centimeter with each individual microperforation being of less than 150 microns. The spacing between adjacent microperforations can be not less than 20 and preferably not more than 600 microns. Desirably the array of a plurality of microperforations is at a density rate of at least 3200 microperforations per square centimeter. In a yet further embodiment the paper substrate comprises a paper with a transparent field wherein in the array of a plurality of laser formed microperforations, each of the microperforations is spaced such that the microperforations create a lensing effect when two transparent fields are overlaid.

Alternatively, the microperforations consist of an array of one or more complex shapes designed so as not to be easily reproducible manually.

In a yet further embodiment the paper substrate has a transparent field, the transparent field comprising an array of a plurality of laser-formed microperforations separated by a land area, the array of microperforations having a density rate of at least 1200, more preferably 2000 microperforation per square centimeter, the percent transmittance of the transparent field being at least 70% as measured by ASTM test method D1726-03.

In a yet alternative embodiment, the paper substrate has a semitransparent watermark field, the semitransparent watermark field comprising an array of a plurality of laser-formed partial ablations separated by raised land areas, the array of partial ablations having a density rate of at least 1200 partial ablations per square centimeter.

### BRIEF DESCRIPTION OF THE DRAWINGS

FIG. 1 is a micrograph of a transparent field comprising a close packed array of a plurality of laser-formed microperforations at a density rate of 20,000 microperforations per square centimeter according to the invention and a magnification of 40×.

FIG. 2 is a graphic representation of a laser formed transparent field according to the invention.

FIG. 3 is a photographic reproduction of a paper with a transparent field overlaid over a second sheet. A puzzle shaped piece is visible in the transparent field.

FIG. 4 is a photographic reproduction of a paper with a transparent field according to the invention.

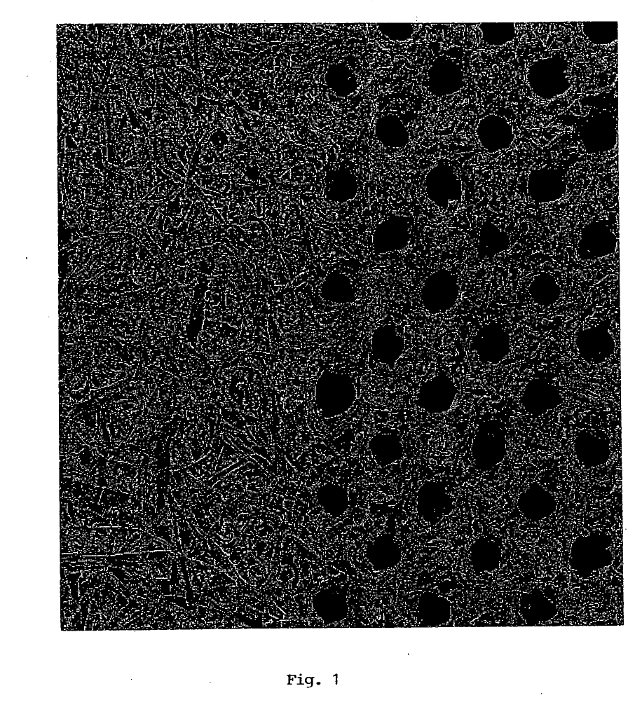

### DETAILED DESCRIPTION

The present invention teaches a transparent paper. In a preferred embodiment the present invention is a paper substrate having a transparent field.

Preferably the transparent field is integral to the document itself though as will be apparent to the skilled artisan, in alternative embodiments it can be applied onto the substrate or laminated or glued or otherwise attached.

In one desirable form, the present invention is a paper substrate having an integral transparent field. The transparent field is an array of a plurality of close-packed laser-formed microperforations. The array is a dense field having a density rate of at least 1200 microperforations per square centimeter. By “density rate” it is meant that the density of microperforations if continued to fill a one centimeter by one centimeter area, the number of microperforations in such area would equal at least the stated density rate.

The transparent field of the paper substrate is surprisingly achieved through use of dense packed or close packed microperforations formed using a laser system. A CO₂ laser system would usually be employed for best results. However, other laser systems including UV and fiber lasers would yield similar results. The microperforations are applied in sufficient density to transparentize the paper yet leaving sufficient fiber as wall material or land area such that sufficient strength characteristics of the paper are retained. Surprisingly the paper can be transparentized with the laser to impart visibility characteristics similar to glassine while retaining the integrity of the paper stock in the transparentized field.

To achieve transparent paper or paper with a transparent field it is useful to preferably select a paper of from 30 to 150 grams or higher per sq meter. Useful papers can be from 2 to about 300 grams per square meter. Uniform fiber and filler distributions in the substrate are desirable to yield consistent transparencies across the substrate. Lighter weight paper substrates tend to be easier to perforate/transparentize. The degree of transparency is believed to be inversely related to paper thickness and directly related to the density of microperforations and the distance between perforations. As a thicker paper is selected, the level of transparency obtained via microperforations tends to be of a lesser degree. For a given substrate, however, the higher the density of the microperforations, the more transparent and the weaker the transparent area becomes. Any weakness however can be effectively offset with the use of a saturation latex or strengthening polymer, if desired or needed. In a situation where a lighter weight substrate is perforated under the same conditions as a heavier weight (thicker) substrate, the lighter weight substrate hole dimensions tend to be slightly larger than the heavier weight substrate hole dimensions. Appropriate beam intensity adjustment can lead to similarity in hole dimensions. It should be noted that both synthetic and regular paper substrates can be transparentized using this process. A highly filled polyester synthetic paper, for instance, yields excellent results.

The paper substrate can be anywhere from about 10 to 400 grams per square meter and preferably 30 to 150 grams per square meter. More preferably writing stock weight or bond weight is employed. Such papers are typically of from 30 to 75 grams per square meter or higher, such as up to 100 grams per square meter. Thicknesses are generally from 30 to 150 microns and preferably from about 60 to 100 microns, and more preferably from 60 to 90 microns. The selection of weight and thickness depends on the intended end use application.

It is important that the land area between adjacent microperforations be kept from 20 to 700 microns, and preferably 20 to 500 microns and more preferably 20 to 400 microns. Similarly the land area between adjacent rows should be within such ranges. If the land area between adjacent rows is kept constant while varying the dimensions of the perforations, one observes that the larger perforations yield substrates with a higher degree of transparency. A typical example is seen in a substrate with a land area of 400 microns between perforations with one set of perforations being 100 microns in diameter and the other set being 50 microns in diameter. The 50 micron sized perforated area is about 50-80% less transparent than the 100 micron sized perforated area in this case.

Preferably the microperforations are circular though other shapes are possible providing the density of the close-packed microperforations can be preserved.

If other shapes are used, the actual number or density of microperforations may differ. For example the shape of the field, rather than being a circle may be in the shape of a square or other shape. The density rate or concentration of microperforations in the areas perforated would be about the stated rate. The density rate can be thought of in terms of the frequency of the occurrence of microperforations in the theoretical one square centimeter area.

The density of microperforations is at least 1200 microperforations per square centimeter, preferably at least 1500 microperforations per square centimeter, and more preferably at least 8000 microperforations per square centimeter and desirably at least 3200 microperforations per square centimeter. Transparency of greater than 70% is perceivable at at least 4000 microperforations per square centimeter. Surprisingly the paper retains sufficient strength in the transparent field that it can function as a glassine window, a security element, or even a writing surface.

The individual microperforations are usually less than 150 microns in diameter usefully less than 120 microns, and preferably 100 microns or less and more preferably 50 microns or less.

It can be desirable to use microperforations approaching 300 to 800 nanometer sizes for specific transparentizing applications.

An important aspect to achieve transparentizing of the paper substrate is to control or select the power of the impinging laser and beam width so as to avoid excessive heat buildup which can result in browning or charring of the substrate. To further reduce discoloration it can be advantageous to equip the laser system with a suction means such as vacuum to draw off outgassing from the substrate surface. If desired an inert atmosphere or gas flow can be supplied in the area of the laser perforating or ablating to further minimize charring or discoloration, and to help cool the substrate.

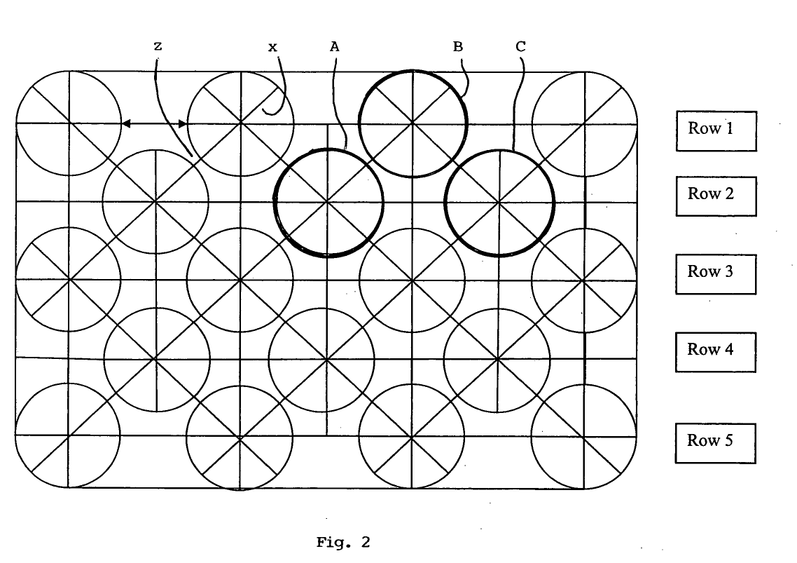

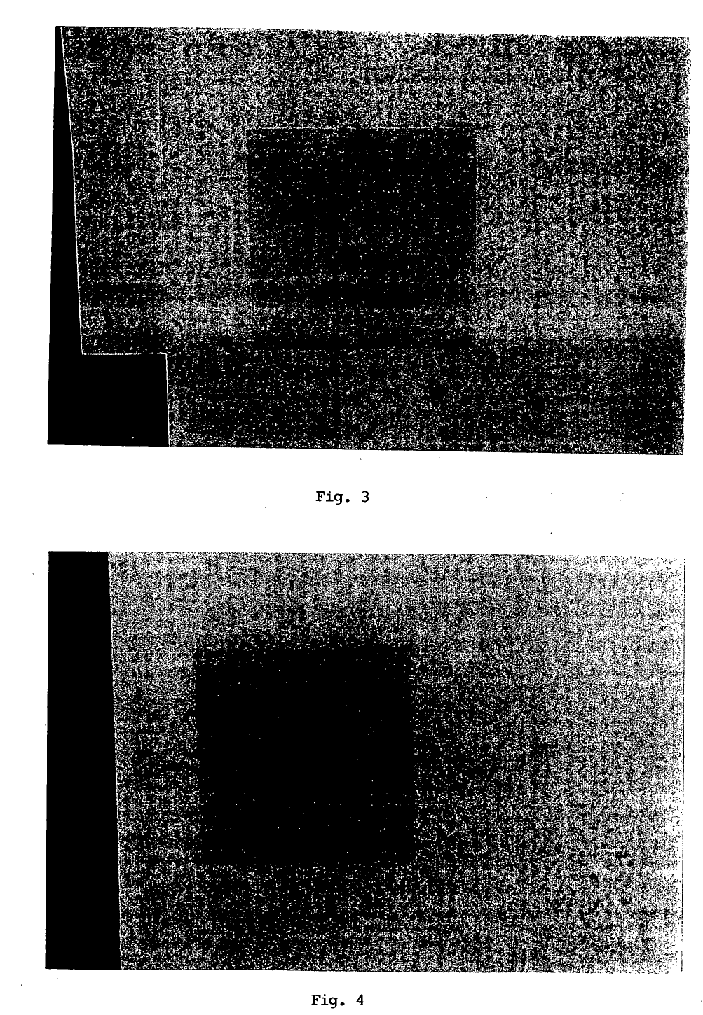

FIG. 2 depicts a typical pattern of microperforations for transparentizing applications. There are five rows and seven columns of holes shown in the diagram. Each hole is X microns in radius and the distance between two adjacent holes in a row or in a column is Y microns. Alternatively, each row or column can be separately spaced or if desirable the spacing need not be orderly. The distance between adjacent holes in rows 1 and 2 is Z microns (or from the center of one hole to the next would be 2X+Z microns). The number of holes per square inch can depend on the values of X, Y and Z in an orderly arrangement. Differing sizes can optionally be employed, for a particular application.

In FIG. 2, microperforation A is shown immediately adjacent to microperforation B. Microperforation C in this pattern would be considered remote and not immediately adjacent to microperforation A for purposes of the formula 2X+Z.

An advantage of the use of microperforations integral to the paper itself is that the paper retains strength even in the areas appearing transparent. To further reinforce the paper, the paper could be optionally further strengthened via saturation or coating with latex or polymeric resin, or lamination to a second substrate.

The saturation latex or strengthening polymer can be selected from various polymeric or film forming materials including various synthetic or natural resins, varnishes, acrylates, methacrylates, urethanes, phenol-formaldehyde polymers, urea-formaldehyde polymers, vinyl resins such as polyvinyl alcohol, starches, methyl or ethyl cellulose emulsion, silane modified acrylates such as taught in U.S. Pat. No. 3,951,893, and various solvent or aqueous based coatings known to the art. Latex stabilization can ensure that the base paper has the requisite strength for the intended end use.

The transparent area also serves as a security feature depending on the design of the perforations (holes, squares, or other complex structures). The design preferably is selected to be such that it cannot be easily reproduced manually or otherwise.

The combination of size and separation between perforations results in a unique or highly secure system for many end use applications.

Similarly, the transparent field itself can take on a variety of shapes such as square or rectangular, circular or other fanciful shape. In an alternative embodiment, the transparent field can be a stripe or ribbon or lace pattern across the length or width of the sheet or web. Creating the transparent field as a stripe (understood for purpose hereof to include ribbon or lace patterns, or multiple stripes, lines or combinations thereof) can create a security paper which is a more economical substitute or replacement for windowing or a windowed thread. The thread portion becomes optional since the pattern of the transparent field as a stripe can be sufficiently original so as to make the use of thread for windowing applications as optional. Additionally, the laser formed transparent field is difficult to recreate by conventional non-laser techniques making even simple transparent fields difficult to counterfeit. When the transparent field is used as a replacement for windowing, the transparency level can be optionally selected to be of a lesser or higher degree.

The transparent area can also act as a self-authentication system. This self authentication is achieved via layering of two transparent areas to produce a lensing effect which would allow verification of perforation size and separation. The lensing effect can be an observable optical effect such as wavelength interference or a diffraction pattern. A simple magnifier may also be used for verification of the perforation size and separation.

A convenient way to measure transparency is to adapt test methods such as ASTM D1746-03. This method describes calculating the percent transmittance as a ratio of the light intensity with a specimen, here the transparent field, being placed in the beam and compared to the light intensity with no specimen in the beam. The transparent field of the invention yields transparent fields having at least 70%, preferably at least 80%, and more preferably at least 90% transmittance.

What is claimed is:

1. A paper substrate having a transparent field, the transparent field comprising an array of a plurality of laser-formed microperforations separated by a land area, the array of microperforations having a density rate of at least 1200 microperforations per square centimeter, the land area separating adjacent microperforations being at least 50 microns and not exceeding 600 microns.

2. The paper substrate according to claim 1 wherein the transparent field is a close packed array of a plurality of laser microperforations having a density rate of at least 2000 microperforation per square centimeter;
each individual microperforation being of less than 150 microns;
the spacing between adjacent microperforations being not less than 20 and not more than 600 microns; and
the array of a plurality of microperforations being at a density rate of at least 3200 microperforations per square centimeter.

3. The paper substrate having a transparent field according to claim 1 wherein in the array of a plurality of laser formed microperforations, each of the microperforations is spaced such that the microperforations create a lensing effect when two transparent fields are overlaid.

4. The paper substrate according to claim 1 having a transparent field wherein the microperforations consist of an array of one or more complex shapes designed so as not to be easily reproducible manually.

5. The paper substrate having a transparent field according to claim 1 such that the transparent areas comprise self authenticating structures.

6. The paper substrate according to claim 1 wherein at least the transparent field includes in addition a latex material applied to the substrate to strengthen the paper.

7. The paper substrate according to claim 1 wherein the distance between immediately adjacent microperforations is Z and the distance between centers of adjacent holes is 2X+Z, wherein X is the radius of each of the adjacent holes.

8. The paper substrate according to claim 1 wherein the transparent field is a square or rectangular area.

9. The paper substrate according to claim 1 wherein the transparent field is a stripe across a width or length of the paper substrate.

10. The paper substrate according to claim 1 wherein the authentication field is in the shape of alphanumeric characters.

11. The paper substrate according to claim 1 wherein the transparent field is a geometric or artistic shape.

12. The paper substrate according to claim 1 wherein a backing sheet is laminated to the paper substrate, the backing sheet being visible through the transparent field.

13. A paper substrate having a transparent field, the transparent field comprising an array of a plurality of laser-formed microperforations separated by a land area, the array of microperforations having a density rate of at least 1200 microperforation per square centimeter, the percent transmittance of the transparent field being at least 70% as measured by ASTM test method D1726-03.

14. The paper substrate according to claim 13 wherein the transparent field is a close packed array of a plurality of laser microperforations having a density rate of at least 2000 microperforation per square centimeter.

15. The paper substrate having a transparent field according to claim 13 wherein the array of a plurality of laser formed microperforations, each of the microperforations is spaced such that the microperforations create lensing effect when two transparent fields are overlaid.

16. The paper substrate according to claim 13 having a transparent field wherein the microperforations consist of an array of one or more complex shapes designed so as not to be easily reproducible manually.

17. The paper substrate having a transparent field according to claim 13 wherein the transparent areas comprise self-authenticating structures.

18. The paper substrate according to claim 13 wherein at least the transparent field includes in addition a latex material applied to the substrate to strengthen the paper.

19. The paper substrate according to claim 13 wherein the distance between immediately adjacent microperforations is Z and the distance between centers of adjacent holes is 2X+Z, wherein X is the distance between adjacent holes.

20. The paper substrate according to claim 13 wherein the transparent field is a square or rectangular area.

21. The paper substrate according to claim 13 wherein the transparent field is a stripe across the width or length of the paper substrate.

22. The paper substrate according to claim 13 wherein the transparent field is in the shape of alphanumeric characters.

23. The paper substrate according to claim 13 wherein the transparent field is selected from a geometric, artistic or ribbon shape.

24. The paper substrate according to claim 13 wherein a backing sheet is laminated to the paper substrate, the backing sheet being visible through the transparent field.

25. A paper substrate having a semitransparent watermark field, the semitransparent watermark field comprising an array of a plurality of laser formed partial ablation separated by raised land areas, the array of partial ablations having a density rate of at least 1200 partial ablations per square centimeter.
